(19) United States
(12) Patent Application Publication
(10) Pub. No.: US 2010/0131270 A1
(43) Pub. Date: May 27, 2010

(54) METHOD AND SYSTEM FOR REDUCING RECEPTION OF UNWANTED MESSAGES

(75) Inventor: Joachim Charzinski, Munchen (DE)

Correspondence Address: Dickinson Wright, PLLC, 1875 Eye Street, NW, Suite 1200, Washington, DC, 20006, US

(73) Assignee: Nokia Siemens Networks GmbH & Co., Munchen (DE)

(21) Appl. No.: 12/373,633

(22) PCT Filed: Jul. 13, 2007
(86) PCT No.: PCT/EP2007/057266

§ 371 Date: Dec. 23, 2009

(30) Foreign Application Priority Data
Jul. 13, 2006 (DE) 10 2006 032 543.5

(51) Int. Cl. G10L 15/00; G10L 19/14

(52) U.S. Cl. 704/234; 704/E15.001

(57) ABSTRACT

The invention relates to a method for determining a characteristic pattern for a speech message that is supplied in the form of a numerically encoded audio signal generated by means of a sampling process. Said method comprises at least the following steps for determining the characteristic pattern on the basis of the numerically encoded audio signal: in a first step, non-speech portions of the audio signal are suppressed in that irrelevant frequency ranges are filtered out by applying a suitable signal filter, particularly a bandpass filter, to the audio signal; in a second step, a copy command (SQR) is used in order to copy all elements of the numerically encoded audio signal into the positive number range; in a third step, an audio signal sampling rate characterizing the sampling process is adjusted; in a fourth step, the new value range of all elements of the numerically encoded audio signal is scaled with regard to a maximum value and a mean value, said new value range being the result of the adjustment of the sampling rate. The invention further relates to a system for carrying out the disclosed method as well as devices and a corresponding communication network.

### CLAIM FOR PRIORITY

This application is a national stage application of PCT/EP2007/057266, filed Jul. 13, 2007, which claims the benefit of priority to German Application No. 10 2006 032 543.5, filed Jul. 13, 2006, the contents of which hereby incorporated by reference.

### TECHNICAL FIELD OF THE INVENTION

The invention relates to a method and a system for reducing the reception of unwanted messages by using feature patterns.

### BACKGROUND OF THE INVENTION

With the increasing spread of Internet telephony (voice over IP, VoIP in brief), it is expected that VoIP users will be increasingly exposed to so-called SPIT (SPAM over Internet Telephony). At present, advertising calls to conventional PSTN (Public Switched Telephone Network) users are normally always charged to the caller. Calls to VoIP users, in contrast, can be made almost free of cost due to the deviating charging model for the caller, which leads to the expectation of a massive SPIT influx for the future. The possibility of sending recorded voice files in masses, in particular, should be of interest to advertisers. It must be assumed that the VoIP users affected will demand suitable measures from their respective VoIP providers in order to be protected against unwanted calls.

Counter measures against SPIT inter alia are so-called white lists and black lists. A white list contains for a user X user-specific information relating to those other users Y in the communication network which have been graded as trustworthy and are thus authorized to call user X. A black list, in contrast, contains user-specific information relating to those other users Y which have been graded as not trustworthy and are thus not authorized to call user X.

However, SPIT protection with the aid of white and black lists is ineffective in the case of an unknown user calling for the first time since the user-specific data of the unknown user cannot be contained either in a white list or a black list of the called user in this case.

It is also conceivable to classify messages also as SPIT on the basis of their similarity to a message previously recognized as SPIT message. If a message occurs in batches, this is also a strong indication of an unwanted message.

However, an exact comparison, for example in the form of a pure comparison at the level of the bit streams representing the messages to be compared, does not lead to the target since even a slight modification, which is inaudible to the called party, for example due to recoding or an accidental delay at the beginning of the message, would lead to a difference between the messages compared.

### SUMMARY OF THE INVENTION

The invention discloses a method and a system to such an extent that the reception of unwanted messages in a communication network is reduced.

One embodiment of the invention is a method for determining a feature pattern for a voice message, the voice message being present in the form of a numerically coded audio signal generated by sampling. The method comprises at least the following steps for determining the feature pattern on the basis of the numerically coded audio signal:

In a first step, non-voice portions of the audio signal are suppressed by filtering out irrelevant frequency ranges during an application of a suitable signal filter to the audio signal, particularly application of a bandpass filter.

In a second step, a mapping rule (SQR) is applied for mapping all elements of the numerically coded audio signal into the range of the positive numbers.

In a third step, a sampling rate of the audio signal, characterizing the sampling, is adapted.

In a fourth step, the new range of values, produced by the adaptation of the sampling rate, of all elements of the numerically coded audio signal is normalized with respect to a maximum value and a mean value.

The invention also relates to a system for carrying out the method represented and to devices and a corresponding communication network.

The invention entails the advantage that the reception of unwanted messages is reduced.

### BRIEF DESCRIPTION OF THE DRAWINGS

An example of the embodiment of the invention is represented in the drawings and will be described in greater detail in the text which follows.

FIG. 1 shows a block diagram for generating a feature pattern for a message.

FIG. 2 shows variants for generating the feature pattern FP with an additional differentiator.

FIG. 3 shows variants for generating the feature pattern with an additional threshold filter SWF and sample counter.

FIG. 4 shows a comparison of two feature patterns for two messages

### DETAILED DESCRIPTION OF THE INVENTION

According to the invention, a feature pattern FP is determined for a message M. In this context, the message M is a voice message in a communication network, for example a Voice over IP communication network. The message M is available in the form of a numerically coded audio signal generated by sampling. The method according to the invention is characterized by a plurality of steps during which the feature pattern FP is determined on the basis of the numerically coded audio signal. The determination of the feature pattern FP is here irreversible, the message M can thus not be reconstructed out of the feature pattern FP.

The feature pattern FP determined can be, for example, stored and/or transmitted to portions within or outside of the communication network for further processing. It is also possible to compare the feature pattern FP determined with a second feature pattern FP of a second message M and to determine whether the two messages match one another in contents.

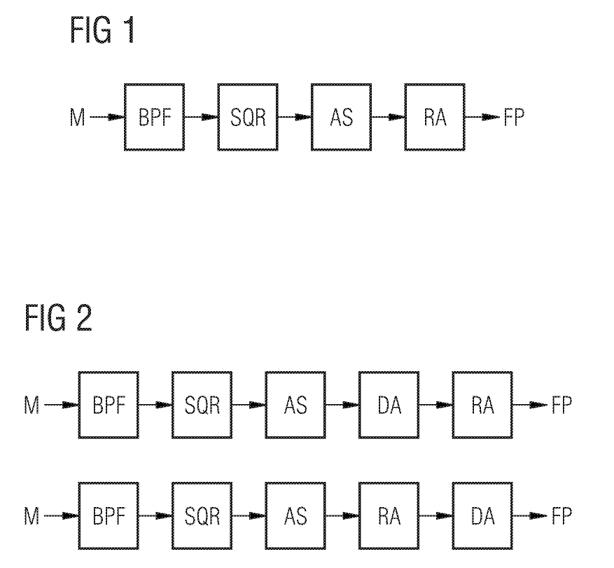

FIG. 1 shows a block diagram for generating a feature pattern FP from a message M. In the text which follows, the steps represented in the block diagram will be explained.

Firstly, non-voice portions of the audio signal are suppressed in a first step by filtering out irrelevant frequency ranges during an application of a suitable signal filter to the audio signal. In this context, the application of a bandpass filter BPF is particularly advantageous since the bandpass filter BPF mainly leaves the frequency range relevant to voice unchanged but largely filters out non-voice portions.

In a second step, a mapping rule SQR is applied for mapping all elements of the numerically coded audio signal (samples) into the range of the positive numbers. The mapping rule SQR advantageously represents, for example, a squaring or absolute-value module: In the case of the squaring module, all elements of the numerically coded audio signal are squared, in the case of the absolute-value module, the corresponding amount is formed for all elements of the numerically coded audio signal.

In a third step, a sampling rate of the audio signal, characterizing the sampling, is adapted by means of an addition module AS. The addition module AS in each case incrementally combines a set of elements of the numerically coded audio signal, resulting in an altered sampling rate of the audio signal. The number n of samples combined per second is adjustable.

In a fourth step, the new range of values, produced by the adaptation of the sampling rate, of all elements of the numerically coded audio signal is normalized with respect to a maximum value and a mean value by means of a normalizer RA. The normalizer RA preferably performs a linear transformation of the samples of the audio signal in such a manner that a normalization to a maximum value of 1 and a mean value of 0 is carried out.

Following the method shown, all modified elements of the numerically coded audio signal are output. The result of the method represented is a sequence of numbers between −1 and 1 which represent the feature pattern FP for the message M.

The sequence of steps represented above is variable and not restricted to the sequence shown. In particular, steps can be left out, reordered or carried out several times.

In a further embodiment of the invention, in an additional restriction step, the duration in time of the audio signal is restricted to a predetermined measure, wherein the restriction step can be carried out at any point in the method. The limiting of the length preferably occurs as early as possible in the sequence of steps in order to minimize the computing effort in the subsequent steps.

In a further embodiment of the invention, the DC portion of the audio signal is removed before the bandpass filter BPF is applied, the DC portion representing the long-term mean value of the audio signal.

FIG. 2 shows variants for generating the feature pattern FP with an additional differentiator DA. The differentiator DA provides for a sequence of samples xᵢ, i=1, 2, . . . , N a second sequence of samples yᵢ=xᵢ₊₁−xᵢ, i=1, 2, . . . N−1. In this manner, the change in energy from one time interval to the next is used as weighting quantity instead of the energy in the individual time intervals. The application of the differentiator DA advantageously results in a robustness against superimposed disturbances such as, for example, interference signals of constant volume. As shown in FIG. 2, the differentiator DA is preferably applied after the addition module AS or after the normalizer RA.

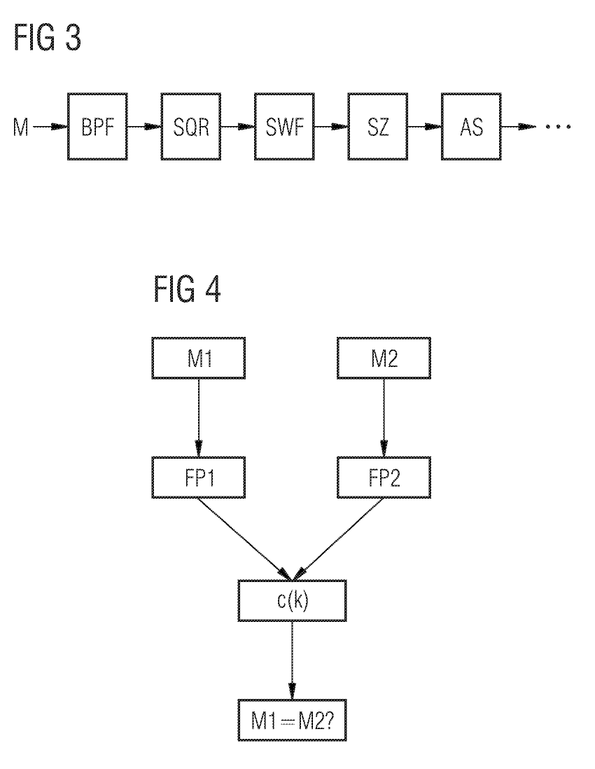

FIG. 3 shows a variant for generating the feature pattern FP with an additional threshold filter SWF and a sample counter SZ. Applying the threshold filter SWF filters all sample values out of the audio signal which are below a limit value. Applying the sample counter SZ ensures that the number of samples of the resultant feature pattern is correct. This makes it possible, for example, to filter out very quiet portions of the audio signal. The threshold filter SWF and the sample counter SZ can be applied at any point in the method shown above. The threshold filter SWF is preferably applied after the bandpass filter BPF and before the normalizer RA and before a possible application of the differentiator DA.

FIG. 4 shows the comparison of two feature patterns FP1, FP2 for two messages M1, M2. The method according to the invention makes it possible to compare a first message M1 on the basis of a first calculated feature pattern FP1 with a second feature pattern FP2 of a second message M2. This makes it possible to determine whether two messages M1, M2 are identical or almost identical in contents.

For the comparison of a second feature pattern FP2 of a second message M2 with a first feature pattern FP1 of a first message M1, the cross correlation function c(k) of the two feature patterns is determined. This function c(k) is defined as follows for two data series s1(i) and s2(j), the two data series representing the samples of the first and of the second message, respectively:

$$c ( k ) = {\sum }_{i = - ∞}^{∞} {s}_{1} ( i ) {S}_{2} ( i - k )$$

If one of the result values of the correlation function c(k) exceeds a predetermined threshold value, the messages are classified as identical. Otherwise, the messages are assessed as being nonidentical.

In a further embodiment of the invention, a continuous or a multi-step measure for the equality of two messages M1, M2 can be derived from the maximum value of c(k). In this context, a continuous measure for the equality has an infinite number of intermediate steps but a multi-step measure, in contrast, only has a finite number of intermediate steps.

In a further embodiment of the invention, the ratio C1/C0 between the maximum of the cross correlation function c(k) and the maximum C0 of the autocorrelation function (feature pattern of the first message M1 correlates with itself) can also be used for determining a measure for the equality of two messages M1, M2.

In a further embodiment of the invention, the threshold value predetermined with respect to the correlation function c(k) or the reference value for a multi-step classification can be determined from the auto- and cross-correlation functions of other messages stored in the system.

The method according to the invention is efficient since a feature pattern FP for a message M only contains a small amount of data. In this manner, the feature space based on a message M is greatly reduced. The small amount of data per feature pattern FP allows, for example, very efficient storage and/or retransmission of a feature pattern FP within a communication system. In contrast to a bit-by-bit comparison of messages M or a comparison of values derived directly from the audio signal of a message M such as, for example, hash values, the method according to the invention is also suitable for comparing messages which have been digitized independently of one another—for example after transmission by an analog voice network or recoding of the messages. Furthermore, the method according to the invention is insensitive to a certain measure of superimposed interfering noises in various variants of a message M. Messages M of equal or almost equal contents can be recognized reliably and robustly. Messages of identical contents in principle can be reliably recognized even with relatively small differences between two messages M1, M2 such as, for example, a different form of address or the insertion of small individual portions into one of the messages M1, M2. The method thus makes it possible to determine that two messages M1, M2 carry the same voice information with high probability. The resultant magnitude of the feature patterns FP1, FP2 can be influenced here by adapting the data rate and by limiting the length of the audio signal.

A further advantage of the invention lies in that, although a feature pattern FP1 for a message M1 is suitable for comparison with a second feature pattern FP2 for a second message M2, the original voice message can no longer be calculated back from a feature pattern FP1, FP2. This is the only way in which the method can also be used in a distributed analysis system in which feature patterns are transmitted in the communication network with the aim of comparison without the receiver obtaining knowledge of the original voice message therefrom.

In one embodiment of the invention, the method according to the invention is carried out by a voice box server.

In a further embodiment of the invention, the method according to the invention is carried out by at least one client and at least one server in a communication network, wherein the client determines a feature pattern FP for a message M and wherein the server carries out the comparison of feature patterns FP for various messages M. In this process, the client represents, for example, a network-based voice box system or a terminal such as, for example, an answering machine. The server is provided, for example, by a network operator as part of an answering machine service. As an alternative, the server can also be offered by an independent operator.

1. A method for determining a feature pattern for a voice message, the voice message being present in the form of a numerically coded audio signal generated by sampling, comprising:
suppressing non-voice portions of the audio signal by filtering out irrelevant frequency ranges during an application of a signal filter to the audio signal;
applying a mapping rule for mapping all elements of the numerically coded audio signal into the range of the positive numbers;
adapting a sampling rate of the audio signal characterizing the sampling; and
normalizing a new range of values, produced by the adaptation of the sampling rate, of all elements of the numerically coded audio signal with respect to a maximum value and a mean value.

2. The method as claimed in claim 1, wherein at least one of:
the sequence of the method is variable;
one or more method steps can be skipped or applied repeatedly; and
determination of the feature pattern is irreversible.

3. The method as claimed in claim 1,
further comprising restricting duration in time of the audio signal to a predetermined measure.

4. The method as claimed in claim 1, further comprising:
determining a second sequence of samples yᵢ=xᵢ₊₁−xᵢ, i=1, 2, . . . N−1 by means of a differentiator for a sequence of samples xᵢ, i=1, 2, . . . , N representing the audio signal so that, instead of absolute sample values of the audio signal, a difference between two successive sample values is used for determining the feature pattern.

5. The method as claimed in claim 1, wherein
before non-voice portions of the audio signal are suppressed, a DC portion of the audio signal is removed, the DC portion representing the long-term mean value of the audio signal.

6. A method for comparing contents of voice messages, comprising:
determining a first feature pattern for a first voice message, including:
suppressing non-voice portions of the audio signal by filtering out irrelevant frequency ranges during an application of a signal filter to the audio signal,
applying a mapping rule for mapping all elements of the numerically coded audio signal into the range of the positive numbers,
adapting a sampling rate of the audio signal characterizing the sampling, and
normalizing a new range of values, produced by the adaptation of the sampling rate, of all elements of the numerically coded audio signal with respect to a maximum value and a mean value;
determining a second feature pattern for a second voice message, including:
suppressing non-voice portions of the audio signal by filtering out irrelevant frequency ranges during an application of a signal filter to the audio signal, applying a mapping rule for mapping all elements of the numerically coded audio signal into the range of the positive numbers,
adapting a sampling rate of the audio signal characterizing the sampling, and
normalizing a new range of values, produced by the adaptation of the sampling rate, of all elements of the numerically coded audio signal with respect to a maximum value and a mean value; and
comparing the first and the second feature pattern by means of a cross correlation function,
wherein the first and the second voice message are assessed to be identical with respect to their contents if at least one value from the result set of the cross correlation function exceeds a predetermined threshold value.

7. A system for identifying substantially identical voice messages with a device for comparing the contents of voice messages, the device determining a first feature pattern for a first voice message, including:
suppressing non-voice portions of the audio signal by filtering out irrelevant frequency ranges during an application of a signal filter to the audio signal,
applying a mapping rule for mapping all elements of the numerically coded audio signal into the range of the positive numbers,
adapting a sampling rate of the audio signal characterizing the sampling, and
normalizing a new range of values, produced by the adaptation of the sampling rate, of all elements of the numerically coded audio signal with respect to a maximum value and a mean value;
determining a second feature pattern for a second voice message, including:
suppressing non-voice portions of the audio signal by filtering out irrelevant frequency ranges during an application of a signal filter to the audio signal,
applying a mapping rule for mapping all elements of the numerically coded audio signal into the range of the positive numbers,
adapting a sampling rate of the audio signal characterizing the sampling, and
normalizing a new range of values, produced by the adaptation of the sampling rate, of all elements of the numerically coded audio signal with respect to a maximum value and a mean value; and
comparing the first and the second feature pattern by means of a cross correlation function,
wherein the first and the second voice message are assessed to be identical with respect to their contents if at least one value from the result set of the cross correlation function exceeds a predetermined threshold value.

8. A communication network having at least one system for identifying substantially identical voice messages with a device for comparing the contents of voice messages, the device determining a first feature pattern for a first voice message, including:
suppressing non-voice portions of the audio signal by filtering out irrelevant frequency ranges during an application of a signal filter to the audio signal,
applying a mapping rule for mapping all elements of the numerically coded audio signal into the range of the positive numbers,
adapting a sampling rate of the audio signal characterizing the sampling, and normalizing a new range of values, produced by the adaptation of the sampling rate, of all elements of the numerically coded audio signal with respect to a maximum value and a mean value;
determining a second feature pattern for a second voice message, including:
suppressing non-voice portions of the audio signal by filtering out irrelevant frequency ranges during an application of a signal filter to the audio signal,
applying a mapping rule for mapping all elements of the numerically coded audio signal into the range of the positive numbers,
adapting a sampling rate of the audio signal characterizing the sampling, and normalizing a new range of values, produced by the adaptation of the sampling rate, of all elements of the numerically coded audio signal with respect to a maximum value and a mean value; and
comparing the first and the second feature pattern by means of a cross correlation function,
wherein the first and the second voice message are assessed to be identical with respect to their contents if at least one value from the result set of the cross correlation function exceeds a predetermined threshold value.

9. The communication network as claimed in claim 8, wherein the communication network represents a Voice over IP communication network.

10. A voice box server with a device for determining a feature pattern for a voice message, the voice message being present in the form of a numerically coded audio signal generated by sampling, comprising:
suppressing non-voice portions of the audio signal by filtering out irrelevant frequency ranges during an application of a signal filter to the audio signal;
applying a mapping rule for mapping all elements of the numerically coded audio signal into the range of the positive numbers;
adapting a sampling rate of the audio signal characterizing the sampling; and
normalizing a new range of values, produced by the adaptation of the sampling rate, of all elements of the numerically coded audio signal with respect to a maximum value and a mean value.

11. A client with a device for determining a feature pattern for a message for a voice message, the voice message being present in the form of a numerically coded audio signal generated by sampling, comprising:
suppressing non-voice portions of the audio signal by filtering out irrelevant frequency ranges during an application of a signal filter to the audio signal;
applying a mapping rule for mapping all elements of the numerically coded audio signal into the range of the positive numbers;
adapting a sampling rate of the audio signal characterizing the sampling; and
normalizing a new range of values, produced by the adaptation of the sampling rate, of all elements of the numerically coded audio signal with respect to a maximum value and a mean value.

12. A server with a device for comparing the contents of voice messages, comprising:
determining a first feature pattern for a first voice message, including:
suppressing non-voice portions of the audio signal by filtering out irrelevant frequency ranges during an application of a signal filter to the audio signal,
applying a mapping rule for mapping all elements of the numerically coded audio signal into the range of the positive numbers,
adapting a sampling rate of the audio signal characterizing the sampling, and
normalizing a new range of values, produced by the adaptation of the sampling rate, of all elements of the numerically coded audio signal with respect to a maximum value and a mean value;
determining a second feature pattern for a second voice message, including:
suppressing non-voice portions of the audio signal by filtering out irrelevant frequency ranges during an application of a signal filter to the audio signal, applying a mapping rule for mapping all elements of the numerically coded audio signal into the range of the positive numbers,
adapting a sampling rate of the audio signal characterizing the sampling, and normalizing a new range of values, produced by the adaptation of the sampling rate, of all elements of the numerically coded audio signal with respect to a maximum value and a mean value; and
comparing the first and the second feature pattern by means of a cross correlation function,
wherein the first and the second voice message are assessed to be identical with respect to their contents if at least one value from the result set of the cross correlation function exceeds a predetermined threshold value.

13. (canceled)

14. (canceled)
